(19) United States
(12) Patent Application Publication
(10) Pub. No.: US 2016/0210816 A1
(43) Pub. Date: Jul. 21, 2016

(54) CASINO ENTERTAINMENT SYSTEM WITH MANDATORY ADDITIONAL WAGER TIED TO A PREDETERMINED CONDITION

(71) Applicant: Chi Fat Au-Yeung, Birmingham (GB)

(72) Inventor: Chi Fat Au-Yeung, Birmingham (GB)

(21) Appl. No.: 14/945,425

(22) Filed: Nov. 19, 2015

(30) Foreign Application Priority Data
Jan. 20, 2015 (GB) 1500914.5

(51) Int. Cl. G07F 17/32; A63F 1/00

(52) U.S. Cl. CPC G07F 17/3244; A63F 1/00; G07F 17/3293; A63F 2001/001

(57) ABSTRACT

A method, apparatus and computer readable storage to implement a blackjack wagering game in which the player must make a main wager and a mandatory extra wager. The player is offered an advantage on the main wager thereby providing the player a return on the main wager itself that may be greater than a 100% return. If a condition is not met, then the player automatically loses the extra wager, otherwise the player wins the extra wager if the main wager won and loses the extra wager if the main wager lost.

### CROSS REFERENCE TO RELATED APPLICATIONS

This application claims foreign priority to patent application number 1500914.5, filed in the Intellectual Property Office of the United Kingdom on Jan. 20, 2015, which is incorporated by reference herein in its entirety.

### BACKGROUND OF THE INVENTION

1. Field of the Invention

The present general inventive concept is directed to a method, apparatus, and computer readable storage medium directed to a casino wagering game.

2. Description of the Related Art

Casino games are a huge industry in this country.

In one prior art blackjack side bet called “3:1 Blackjack”, if the player's initial two cards are the same color and the player wins the hand, then the side bet pays 3:1 otherwise the side bet loses.

What is needed is a new casino game that will be profitable for the house and exciting and enjoyable for players.

### SUMMARY OF THE INVENTION

It is an aspect of the present invention to provide an exciting casino game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a wagering game, according to an embodiment;

FIG. 2A is a drawing illustrating a gaming table, according to an embodiment;

FIG. 2B is a block diagram illustrating an electronic player tracking system associated with each gaming table, according to an embodiment;

FIG. 3A is a block diagram illustrating exemplary hardware that can be used to implement an electronic version of the methods described herein;

FIG. 3B is a block diagram illustrating an exemplary network configuration to implement a player playing an online version of the methods described herein; and

FIG. 4 illustrates an exemplary method of implementing a poker game, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a casino game which implements a wagering game with a mandatory extra wager which provides the player an additional advantage not previously offered. The player must win a main wager in order to win the extra wager.

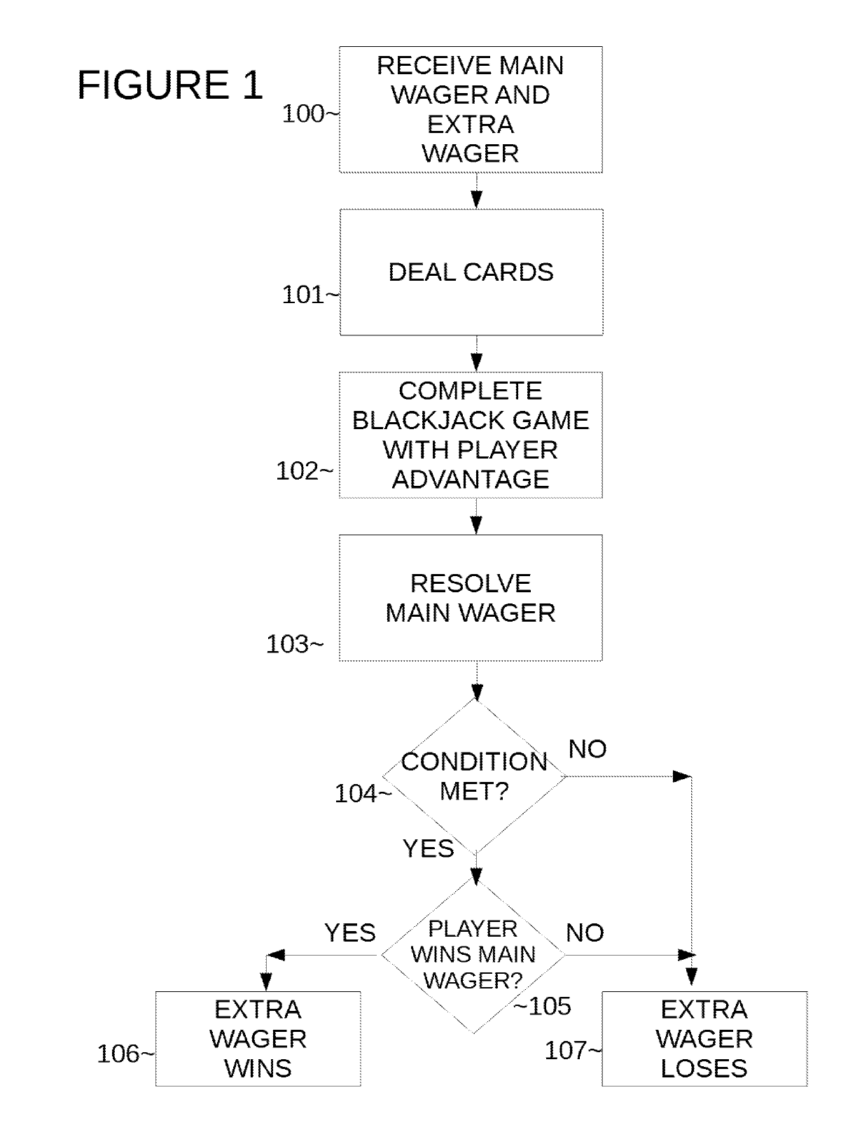

FIG. 1 is a flowchart illustrating an exemplary method of implementing a wagering game, according to an embodiment. The game can for example be blackjack, which is described in U.S. Pat. No. 8,651,489, which is incorporated by reference herein in its entirety.

The method can begin with operation 100, which receives a main wager from the player. The player also places a mandatory extra wager. The extra wager must be one half the value of the main wager, although in another embodiment other multiples can be used as well.

From operation 100, the method proceeds to operation 101, which deals the cards. In a blackjack game, this means dealing the player's initial two cards face up (or face down if the player is able to visually inspect his/her own cards) and the dealer's cards (typically once card face up and one card face down).

From operation 101, the method proceeds to operation 102, which completes the blackjack game with a player advantage. The player advantage means a feature that gives the player a better return than the standard rules of blackjack. The feature is offset by the mandatory extra wager so that the overall return of the main wager and the extra wager is still in the house advantage. For example, if the feature were offered on a regular blackjack game (with no player unfavorable rule changes and only a single player main wager) then the player's return would be greater than 100% (meaning the player could make a profit on the game). But since the extra wager is mandatory, even though the feature may provide the player a greater than 100 return on the main wager, the addition of the extra wager means that the player still cannot beat the house in the long run. The game is completed in operation 102 according to the predetermined blackjack rules.

From operation 102, the method proceeds to operation 103, which resolves the main wager. The main wager is paid (typically even money) if the player's hand wins and the main wager is collected (player loses) if the player's hand loses (is beat by the dealer's hand). If the player's hand ties the dealer's hand then typically this is a push and the main wager neither wins nor loses. In the physical version, the main wager is physically collected or paid. In the virtual version, then a credit display on an electronic output device is increased when the player wins and decreased when the player loses to reflect the outcome of the game.

From operation 103, the method proceeds to operation 104, which determines whether a particular condition is met. This condition is predetermined and can be a variety of different conditions depending on the embodiment being implemented. For example, in one embodiment, the condition is if the player's first two cards add up to an odd number. In another embodiment, the condition is if the player's first two cards are the same color. In a further embodiment, the condition is if the player's first two cards are a different color. It can be appreciated that other conditions can be used as well.

If the condition in operation 104 is not met (e.g., if the condition is that the player's first two cards are the same color but in the game the player's first two cards are different colors) then the method proceeds to operation 107 wherein the extra wager loses and then the game ends.

If the condition in operation 104 is met (e.g., if the condition is that the player's first two cards are the same color and in the game the player's first two cards are actually the same color) then the method proceeds to operation 105.

In operation 105, it is determined whether the player won the main wager (in operation 103). If the player did not win the main wager, then the method proceeds to operation 107 wherein the extra wager loses and the game ends.

If in operation 105 it is determined that the player won the main wager, then the method proceeds to operation 106 wherein the extra wager wins. The payout on the extra wager can be any payout (e.g., 1:1 or 2:1) and is predetermined. Here the game ends.

If in operation 105, the player tied (pushed) the main wager (not pictured in FIG. 1), then the extra wager can also push (neither wins nor loses).

In addition to blackjack, the methods described herein can be applied to a baccarat game as well. Baccarat is a game known in the art and is described in U.S. Pat. No. 8,308,542, which is incorporated by reference herein in its entirety.

In a further embodiment, the methods described herein can be applied to poker. Each player makes a main wager and an extra wager which must be one half of the main wager. The player receives two cards and the extra wager loses If the cards are different colors. If the player's two card poker hand ranks jack or lower, the player may then exchange the two cards for two new cards in the deck. Then, the player receives a third card, and the dealer reveals a dealer's three card hand (previously unrevealed). Traditional three card poker hand rankings are used, and the higher hand wins. If the player's hand ranks higher then the player's main wager wins even money. If the dealer's hand ranks higher than the player's hand, then the player loses his/her main wager. If the extra wager is still live then it is resolved according to a paytable whenever the player's hand beats the dealer's hand. The extra wager would push when the player's hand pushes (has equal rank) to the dealer's hand.

Table I below represents a set of standard three card poker ranks, ranked in order from best (top) to worst (bottom).

TABLE I
Straight flush
Three of a kind
Straight
Flush
Pair
High card
Nothing

Table II below illustrates a set of exemplary rules for the poker variation, according to an embodiment.

TABLE II
1. Each player must place a one unit main game wager and a mandatory 0.5 unit extra
wager before the hand begins.
2. Each player receives 2 cards.
3. If the player's two cards are of different colors, then the player's extra wager
immediately loses, and the dealer collects it. Otherwise, the extra wager remains live.
4. If the player's two cards are Jack-high or lower, he/she may exchange them for two
new cards from the deck.
5. Once all the player's exchange decisions are made, each player receives a third
card to make a three card poker hand.
6. The dealer reveals his three card hand (either newly dealt or previously dealt and now
turned face up)
7. If the player's hand beats the dealer hand, then his/her main game wager wins even
money and his extra wager (if any) pays according to the pay table.
8. If the dealer hand beats the player's hand, then his/her main wager and extra wager (if
any) loses.
9. If the player's hand ties the dealer hand, then his main wager and extra wager (if any)
pushes.

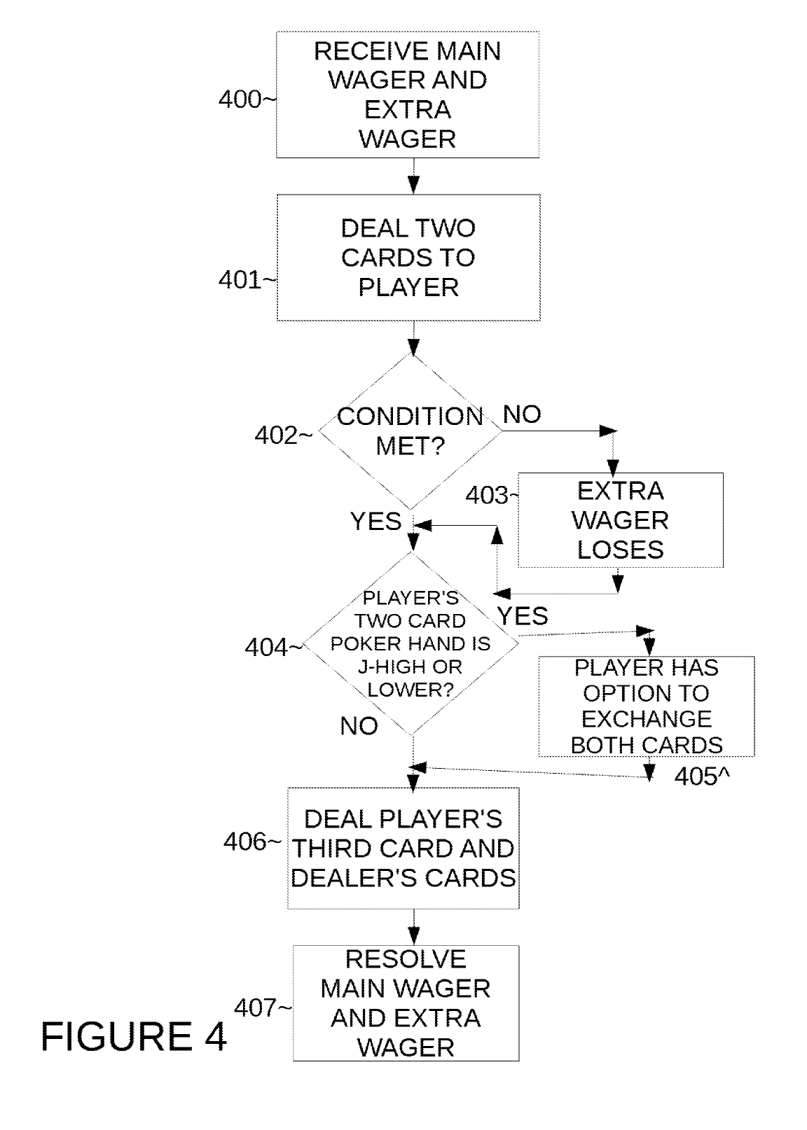

FIG. 4 illustrates an exemplary method of implementing a poker game, according to an embodiment.

The method begins with operation 400, which receives the player's main wager and the extra wager. This can be done as known in the art and described herein.

From operation 400, the method proceeds to operation 401, which deals two cards to the player. The cards are typically dealt face up.

From operation 401, the method proceeds to operation 402, which determines whether a condition is met. The condition is whether the player's two cards (dealt in operation 401) are the same color. If the two cards are different colors, then the method proceeds to operation 403 and the player loses the extra wager. From operations 403 and 402 then the method proceeds to operation 404.

In operation 404, it is determined whether the player's two card poker hand ranks jack or lower. If the player's two card poker hand ranks jack or lower, then the method proceeds to operation 405. If not, then the method proceeds to operation 406.

In operation 405, the player has the option (but is not required) to exchange both cards for two brand newly dealt cards. Then the method proceeds to operation 406.

In operation 406, the dealer deals the player's third card (typically face up) and reveals the dealer's hand of three cards. The dealer's three cards are now dealt face up or can already be dealt previously face down (such as operation 401) and are now all turned face up.

From operation 406, the method proceeds to operation 407, which resolves the player's main wager and the extra wager (if it is still live, in other words the condition has been met).

If the player's hand beats (ranks higher than) the dealer hand, then his/her main game wager wins even money and his extra wager (if live) pays according to the pay table. If the dealer hand beats (ranks higher than) the player's hand, then his/her main wager and extra wager (if live) loses. If the player's hand ties (equal rank) the dealer hand, then his main wager and extra wager (if live) pushes. The extra wager (if live) is paid according to a paytable (if the player wins the main wager), such as the paytable illustrated in Table III based on the player's three card hand.

TABLE III

| Hand | Payout |
|---|---|
| Royal flush | 50 |
| Straight flush | 20 |
| Three of a kind | 10 |
| Straight | 3 |
| Flush | 2 |
| All others | 1 |

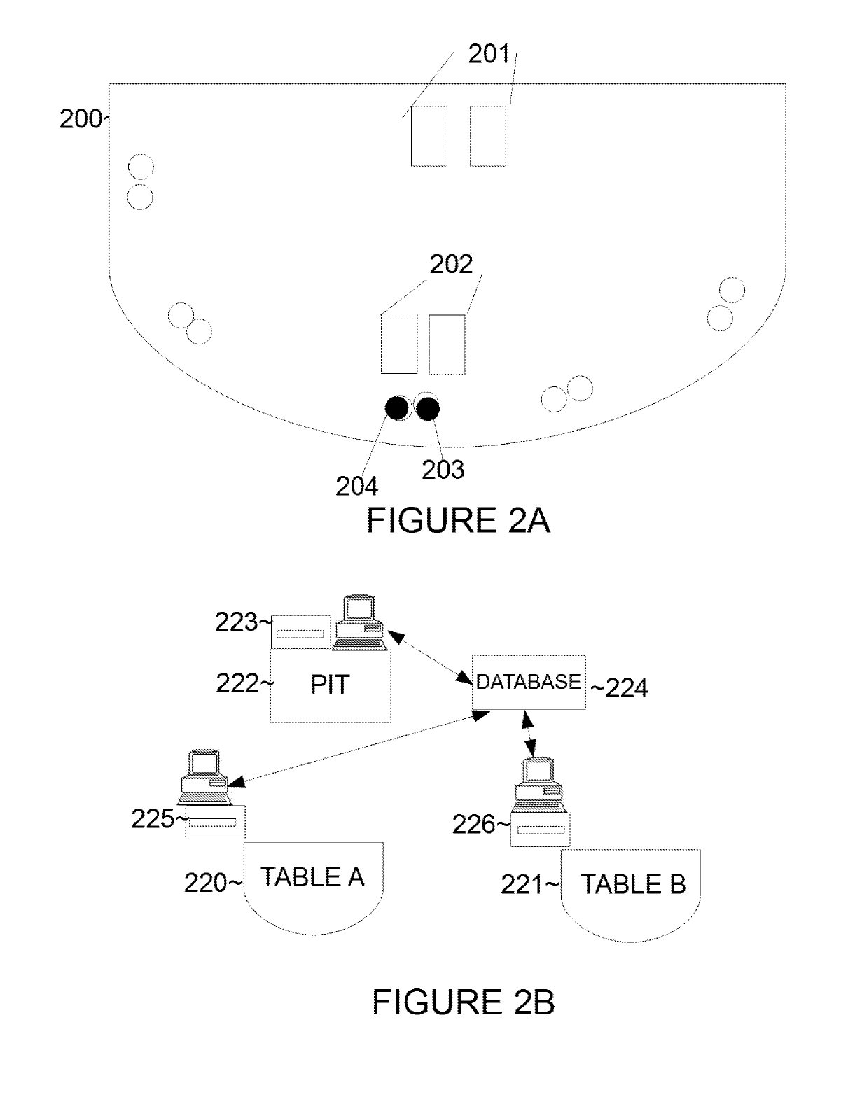

FIG. 2A is a drawing illustrating a gaming table, according to an embodiment.

A physical gaming table 200 (typically made of wood with felt on top with the layout imprinted on it) is used to play the game in a physical real world casino. One example of a table that can be used in a physical casino is illustrated in U.S. Design Pat. D263,975 which is incorporated by reference herein in its entirety. The layout on top of the felt has imprinted on it betting areas for each respective player. In this example, the table can accommodate six simultaneous players (each play against the same dealer hand as known in the art), although of course tables can be configured to accommodate other numbers of players as well. The felt can be green and the imprinted betting areas can be white, although of course any color scheme can be used. A player's hand 202 and a dealer's hand 201 are shown. A player's wager 203 is shown in the form of a chip or chips and is placed inside the player's betting areas. A player's extra wager 204 is also placed inside an extra wager betting circle (betting area). Note that the betting layouts can be configured in any other way, and the layout shown in FIG. 2A is merely one example.

FIG. 2B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 223, 225, 226 which can be electronic read and the data therein transmitted to the associated computer.

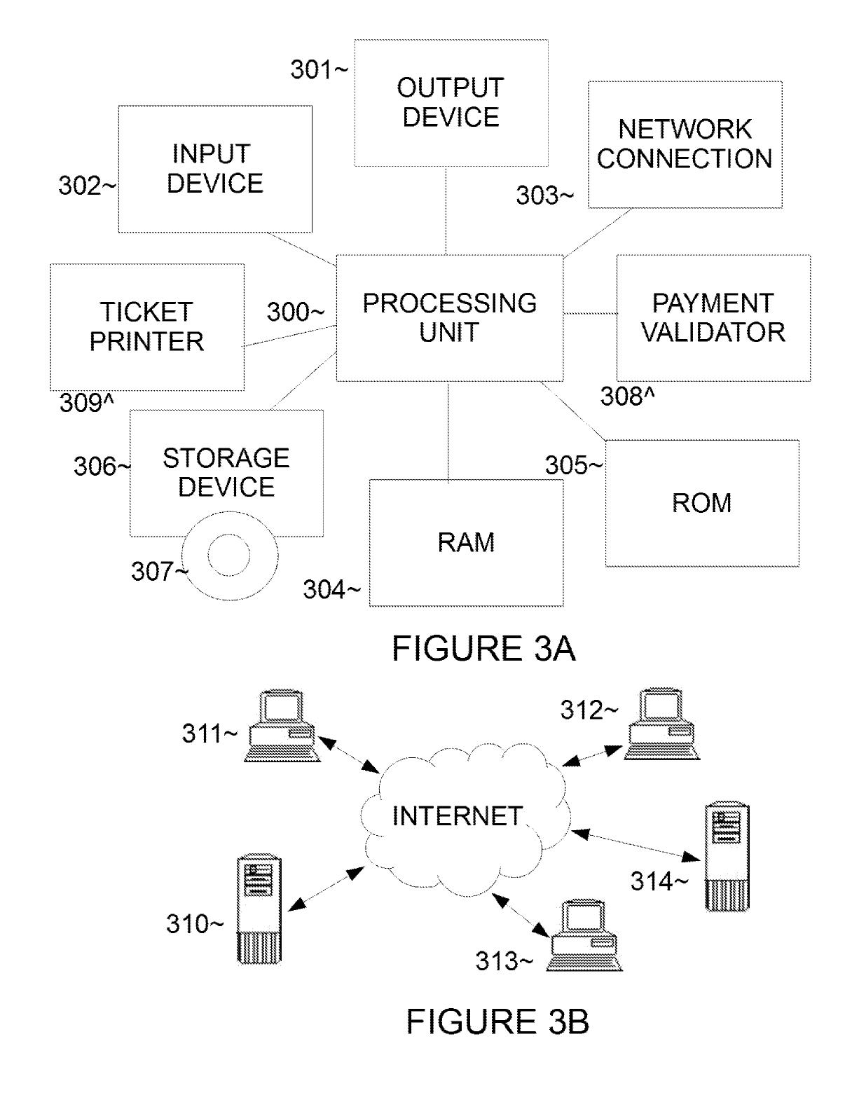

A gaming table A 220 (which can be used to play any method described herein) and a gaming table B 221 (which can be used to play any method described herein) can be associated with a pit 222 (which has its own computer) which has a card reader 223 to read the electronically encoded information on a player's card (the card reader can also be located at the tables themselves) and transmit the information to an associated computer which can communicate information contained on the player's card (e.g., an identification number of the player associated with the card) to the electronic database 224 along with play data relating to the player who owns the player's card. Table A 220 has its own card reader 225 and associated computer (the one next to card reader 325 which receives information from the card reader 225) and table B 221 also has its own card reader 226 and associated computer (the one next to card reader 226 which receives information from the card reader 226). The computers at table A 220 and table B 221 are connected to the electronic database 224. Casino employees can enter data regarding each player's play (for those players that present a players card) into a computer at the table or at the pit which transmits the play data (e.g., average bet amount, time of play, etc.) to the electronic casino database 224 that stores playing history information for players at the casino. The computers illustrated in FIG. 2B can all have the structure as illustrated in FIG. 3A.

FIG. 3A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety. The game can also be played on a video slot machine (the kind that is found in physical casinos).

A processing unit 300 (such as a microprocessor and any associated components) is connected to an output device 301 (such as an LCD monitor, touch screen, CRT, etc.) which is used to display to the player any aspect of the method, and an input device 302 (e.g., buttons, a touch screen, a keyboard, mouse, etc.) which can be used to input from the player any decision made by the player. All methods described herein can be performed by the processing unit 300 by loading and executing respective instructions. Multiple such processing units can also work in collaboration with each other (in a same or different physical location). The processing unit 300 can also be connected to a network connection 303, which can connect the electronic gaming device to a computer communications network such as the Internet, a LAN, WAN, etc. The processing unit 300 is also connected to a RAM 304 and a ROM 305. The processing unit 300 is also connected to a storage device 306 which can be a disk drive, DVD-drive, CD-ROM drive, flash memory, etc. A non-transitory computer readable storage medium 307 (e.g., hard disk, CD-ROM, etc.), can store a program which can control the electronic device to perform any of the methods described herein and can be read by the storage device 306.

The processing unit 300 can also be connected to a payment validator 308. The payment validator can be a bill acceptor which accepts currency, identifies it as being valid (typically by using an optical scanner), and then credits the inserted bill amount to the machine (for example inserting a $10 bill will credit the machine with $10 in credits). The bill acceptor can also accept cashless tickets as part of a ‘ticket-in-ticket-out” system, in which tickets (cashless vouchers) have cash value and can be inserted into the payment validator 308. The validator 308 validates the ticket (typically be optically scanning a bar-code), communicating electronically with a casino database to verify the ticket is authentic, and once authenticated then crediting the machine with the respective amount of credits. The payment validator 308 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for playing the machine. If such a card is used, then the player can optionally enter (using a keypad) an amount the player wishes to withdraw from the account associated with the card to credit to the machine.

The processing unit 300 can also be connected to a ticket printer 309 which can print tickets (cashless vouchers). When the player cashes out on the machine (indicated to the machine that the player wishes to cash out and terminate by, typically by pressing a button), a ticket is printed by the ticket printer 309 which carries the amount of credits left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 3B is a network diagram showing a network structure for a social networking web site and players, according to an embodiment. The online game which awards and stores virtual points can also be accomplished by the system illustrated in FIG. 3B.

A computer communications network (such as the Internet) can be used to connect a host server 310 which can host and serve a social networking site. Note that while FIG. 3B shows only one server as the host server 310, the host server 310 can encompass numerous servers all cooperating with each other (whether in the same physical location or not). The host server 310 communicates with players 311, 312, 313 through the Internet (or other computer communication network) and can implement any of the methods herein by executing computer code programmed accordingly. Game server 314 can also implement all games and methods described herein on the site by executing computer code programmed accordingly. The game server 314 is connected to the Internet and can communicate with all of the players 311, 312, 313 directly or indirectly through the social networking site hosted by the host server 310. The game server 314 can cooperate with the host server 310 so that the games run on the game server 314 can be integrated into the social networking site hosted by the host server 310. The game server can also be optional and all of the games can be also hosted on the host server 310, whereby the integration of the games served/hosted by the game server 314 will appear embedded in the social networking site hosted by the host server 310 such that players would typically not realize (or care) that multiple servers are cooperating in order to play games on the social networking site. All of the communications described herein can be effectuated using such a network configuration. Typically, the communications are effectuated on the social networking site itself, thus the players 311, 312, 313 should be logged into the social networking site in order to participate herein, although logging in is not required (e.g., communications can be transmitted using other methods, such as email, IRC chat, instant message, etc.) The host server 310 can communicate with any of the devices illustrated in FIG. 3.

The word “deal” as used herein can mean two things: a) physically deal a card from a deck (real or virtual) face up or face down; b) reveal (turn face up a face down card) which was previously dealt. Thus, “dealing” includes taking a card from the shoe (if one is being used) and putting it on the table (face up or face down), or taking a card from the shoe (if one is being used) and putting it face down on the table and then (at a later point in time) turning it face up. Thus, if a three card hand is dealt two cards face up and one card face down (which is turned face up later), or a three card hand is dealt two cards face up and at a later time the third card is dealt face up, these are equivalent and both fall under the word “deal.” In the electronic embodiment, a dealt card means to display a virtual representation of the randomly chosen card (selected randomly from a virtual deck) of the card face up or face down.

A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, Pinochle deck(s) (consisting of two of each of the 9, 10, jack, queen, king, and ace cards for all four suits (spades, hearts, diamonds, clubs) totaling 48 cards in each deck). The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a game, the method comprising:
providing at least one standard deck(s) of cards;
receiving from the player a main wager and a mandatory extra wager;
providing extra wager resolution rules comprising a) if an initial condition is satisfied and the main wager wins then the extra wager wins, b) if the initial condition is satisfied and the main wager loses then the extra wager loses, c) if the initial condition is not satisfied then the extra wager loses;
dealing an initial player's hand and an initial dealer's hand;
completing the game;
resolving the main wager;
resolving the extra wager using the extra wager resolution rules.

2. The method as recited in claim 1, wherein the game is blackjack and the initial player's hand comprises only two cards.

3. The method as recited in claim 1, wherein the game is baccarat.

4. The method a recited in claim 2, wherein the condition is the player's initial two cards are the same color.

5. The method as recited in claim 2, wherein the condition is the player's two initial cards are opposite colors.

6. The method as recited in claim 2, wherein the condition is that a total of the player's initial two cards is odd.

7. The method as recited in claim 1, wherein when the main wager wins a payout on the main wager is 2:1.

8. The method as recited in claim 1, wherein the extra wager must be one half of main wager.

9. The method as recited in claim 1, wherein the extra wager resolution rules further comprises d) if the initial condition is satisfied and the main wager pushes then the extra wager pushes.

10. The method as recited in claim 1, wherein a payout on the main wager is 1:1.

11. An apparatus for implementing a game, the apparatus comprising:
an electronic input device;
an electronic output device;
an electronic processor connected to the input device and output device, the processor configured to read computer readable instructions which cause the processor to:
provide at least one standard deck(s) of virtual cards;
receive from the player a main wager and a mandatory extra wager;
provide extra wager resolution rules comprising a) if an initial condition is satisfied and the main wager wins then the extra wager wins, b) if the initial condition is satisfied and the main wager loses then the extra wager loses, c) if the initial condition is not satisfied then the extra wager loses;
deal an initial player's hand and an initial dealer's hand;
complete the game;
resolve the main wager;
resolve the extra wager using the extra wager resolution rules.

12. The apparatus as recited in claim 11, wherein the computer readable instructions are further programmed such that the game is blackjack and the initial player's hand comprises only two cards.

13. The apparatus as recited in claim 11, wherein the computer readable instructions are further programmed such that the game is baccarat.

14. The apparatus a recited in claim 12, wherein the computer readable instructions are further programmed such that the condition is the player's initial two cards are the same color.

15. The apparatus as recited in claim 12, wherein the computer readable instructions are further programmed such that the condition is the player's two initial cards are opposite colors.

16. The apparatus as recited in claim 12, wherein the computer readable instructions are further programmed such that the condition is that a total of the player's initial two cards is odd.

17. The apparatus as recited in claim 11, wherein the computer readable instructions are further programmed such that when the main wager wins a payout on the main wager is 2:1.

18. The apparatus as recited in claim 11, wherein the computer readable instructions are further programmed such that the extra wager must be one half of main wager.

19. The apparatus as recited in claim 11, wherein the computer readable instructions are further programmed such that the extra wager resolution rules further comprises d) if the initial condition is satisfied and the main wager pushes then the extra wager pushes.

20. A method for implementing a game, the method comprising:
providing at least one standard deck(s) of cards;
receiving from the player a main wager and a mandatory extra wager;
providing extra wager resolution rules comprising a) if an initial condition is satisfied and the main wager wins then the extra wager wins, b) if the initial condition is satisfied and the main wager loses then the extra wager loses, c) if the initial condition is not satisfied then the extra wager loses;
dealing an initial player's partial hand;
provide the player an option to exchange the initial player's partial hand for a newly dealt partial hand;
deal at least one additional card to the player's partial hand to form a final player's hand;
reveal a dealer's final hand;
resolve the main wager based on a comparison between the final player's hand and the dealer's final hand; and
resolving the extra wager using the extra wager resolution rules.
